(19) United States
(12) Patent Application Publication
(10) Pub. No.: US 2011/0248583 A1
(43) Pub. Date: Oct. 13, 2011

(54) Power Transmission Tool And System

(75) Inventor: Michael L. O'Banion, Westminster, MD (US)

(73) Assignee: ATLAS DYNAMIC DEVICES, LLC, Westminster, MD (US)

(21) Appl. No.: 13/157,084

(22) Filed: Jun. 9, 2011

Related U.S. Application Data
(63) Continuation-in-part of application No. 12/069,118, filed on Feb. 7, 2008, now Pat. No. 7,990,005.
(60) Provisional application No. 61/353,446, filed on Jun. 10, 2010.

(51) Int. Cl. H02K 7/14; B23P 19/00

(52) U.S. Cl. 310/50; 29/700

(57) ABSTRACT

An improved power tool system includes a power tool having a motor and a controller enclosed within a motor and controller housing, with the motor and controller sealingly coupled with the motor to prevent liquids and gasses from entering the motor and controller housing. In one aspect, the motor and controller housing comprises first and second interfitting components. In another aspect, a fixture for manufacturing a motor and controller housing includes a base with first and second angularly disposed support surfaces, and a pressing member received between the first and second support surfaces.

### CROSS-REFERENCE

This application is a continuation-in-part of U.S. patent application Ser. No. 12/069,118, filed Feb. 7, 2008 (pending), and claims the priority of U.S. Provisional Patent Application Serial No. 61/353,446, filed Jun. 10, 2010 (pending), the disclosures of which are incorporated by reference herein in their entirety.

### TECHNICAL FIELD

This invention relates to a power tool which may be used in and around environments which may be exposed to flammable substances while providing a configuration which is conducive for the operator to handle while transmitting high torque to the application.

### BACKGROUND

Historically, power tools have been made to be lightweight yet provide a high level of power yielding a high power density. This was achieved by utilizing a type of motor called a universal motor.

A universal motor requires carbon brushes to transmit and commutate electricity to the rotating armature. The universal motor typically employs an air moving fan to move air through the motor housing to exhaust the heat from the motor. These motors typically operate at mains voltage supplies from roughly 10V AC to 240V AC.

Typically, power tools of this type use a snap acting contactor line switch to make and break the supply of the electric power supply.

This construction will allow any potentially explosive gasses to become ignited as the cooling fan causes them to flow through the tool and come in contact with either the electric arc at the brushes or the switch.

One such system is described in U.S. Pat. No. 2,155,082, the Decker patent where he describes a motor with brushes, a fan to produce airflow, air openings in the field case through which the air passes, a switch and gearcase.

Another type of power tool well known in the trade is the type powered by a battery. The motor typically utilized to power these tools is a permanent magnet motor. The permanent magnet motor operates from voltages of typically between 8V DC to 36V DC. The electric current is conducted from the battery through carbon brushes to the rotating armature. This so called “Cordless Power Tool” also employs a switch with contacts which cause an arc when the switch is operated. This type of tool offers the user the freedom of operation without a cord. However the tools are limited in their ability to transmit large amount of power for an extended period of time due to the finite amount of energy in the battery.

Typical universal motor and a typical permanent magnet motor produces a speed torque characteristic such that the torque is at a maximum when the speed is at zero rpm. This characteristic causes the motor and load to accelerate very quickly to full rpm. Typically this acceleration occurs in approximately 0.05 seconds.

Power tools may employ a brushless DC motor. This type of motor typically may produce a combination of speed and torque which produce a high power density similar to that of the previously mentioned motors. These motors do not employ carbon brushes and a rotating commutator to function thereby. Therefore, they do not produce any arc during operation. Yamamoto U.S. Pat. No. 7,053,567 discloses a brushless DC motor for use in a power tool. However this type of motor is controlled with a computer and an electronic switching circuit which characteristically produces a signature of electromagnetic interference (EMI).

Applications exist which demand a high torque and speed over an extended period of time. Some applications, for example aboard a Naval Aircraft Carrier, have such a requirement. These applications often require a large amount of power to complete the necessary work. The amount of power required is significantly greater than is practical to be stored in a portable battery attached to a tool.

These applications have the need to move a substantial mass in addition to the requirement for high torque and speed. Starting and stopping such a mass with a power driver such as a compressed air powered ratchet wrench, causes an adverse reaction to the operator. This reaction may result in a large force reaction which the operator must counteract.

Some such applications for high power requirements are subject to exposure to potentially dangerous fluids and gasses such as on an aircraft carrier or in an aircraft hangar. Additionally, these applications may be exposed to salt spray and rain. Additionally, the ambient temperature on board an aircraft carrier, for example may be very extreme ranging from a negative 40 degrees Celsius to a positive 60 degrees Celsius.

Any applications such as those mentioned have the additional requirement to be very mobile. Lui U.S. Pat. No. 7,109,613 discloses a power tool which is protected from liquids. The invention describes an enclosure which protects the motor from liquids with a thermally conductive part that is exposed to the exterior outside the body for the purpose of conducting heat from the motor for heat dissipation. Lui however is limited to dissipating heat to the outside through one end of the motor enclosure which is necessarily limited in surface area and consequentially may not conduct a large amount of heat at an ambient temperature of 60 degrees Celsius.

Vanjani U.S. Pat. No. 6,104,112 teaches of a sealed brushless DC motor with an integral controller. However Vanjani discloses the need for a heat sink, however, the invention provides a heat flow path for only the electronic controller and not the motor.

The Onsrud U.S. Pat. No. 2,862,120 discloses an efficient means of transferring heat from a sealed motor compartment to the exterior with a pair of eccentric shells separated by a series of variously dimensioned axially extending radial baffle ribs. The Onsrud patent however does not disclose the means for moving the cooling fluid past the cooling ribs.

Several applications, such as tasks to be performed on the deck of an aircraft carrier, require power to be transmitted quickly in environments which may become exposed to jet fuel or explosives from ammunition. These applications do not utilize mains power or compressed air due to the difficulty and hazard of dragging hoses or cable across the busy flight deck. Also it is not practical to use a gasoline powered compressor or generator as gasoline is not permitted on the flight deck due to the hazardous nature of gasoline. Diesel powered generators or compressors while permitted on a flight deck, are not practical due to the extreme weight which renders them not portable enough to rapidly deploy from application to application. Consequently, for many of these applications a manual hand powered crank tool, or speed wrench much like one manufactured by “Snap on Tools” Speeder, 187/8″ Stock #S4 is employed. The use of this type of hand tool is extremely fatiguing for the operator and consequently the application is not completed as quickly as desired.

One such application is loading 20 mm artillery rounds into the magazine of a Gatling gun mounted in a jet fighter as one step in preparing the fighter to be redeployed. These rounds are entrained in a long chain which is stored in an ammunition storage car. The chain of ammunition stored is typically a quantity of 5000 to 6000 rounds. In addition to the rounds mass is the mass of the carrier chain which contributes to a substantial inertia. The ammunition is then transferred to the magazine inside the gun on the aircraft. A mechanism internal to the gun is a cranking mechanism which moves the chain of rounds into the gun and thereby fills the guns magazine with 500 to 550 rounds. This cranking mechanism requires approximately 20 to 25 foot pounds of torque to operate. The mechanism in the gun has a maximum torque capability which must not be exceeded or failure of the mechanism may result.

The operator must stand on a small elevated platform to allow him to be accessible to the gun cranking mechanism. The precarious position of the operator requires a smooth transfer of torque so as to not cause him to lose his balance and fall. A power tool such as described in the Godfrey U.S. Pat. No. 3,244,030 would provide a measure of control for management of the torque due to the positioning of the handle on an “L” shaped drill housing.

An additional application is to elevate the hinged wing sections of jet aircraft to allow more compact storage aboard aircraft carriers. Internal to the stationary portion of the aircraft wing is a crank mechanism which when rotated lifts the wing portion to the folded position. This typically requires a torque of between 20 to 25 foot pounds and requires approximately 300 revolutions to fully lift the wing. The wing elevation mechanism has a maximum torque capability which must not be exceeded or failure of the mechanism may result.

The application of cranking the wing up to the folded position and down to the deployed position requires both clockwise and counterclockwise rotation of the mechanism. A motorized means of raising and lowering the wing should have a means to assure the rotational direction of the motor does not change during operation. Cuneo U.S. Pat. No. 4,381,037 describes a means to prevent inadvertent motor reversal.

These two applications are now performed with a speed wrench. These operations require a team of up to five workers due to the intensity and fatigue of the operation.

### SUMMARY

It is, accordingly, an object of the invention to provide a power tool and system which can deliver a combination of speed and torque for an extended period of time, to start and stop a large inertia without adverse reaction to the user, and to operate in a potentially hazardous environment like an aircraft hangar or aircraft carrier flight deck.

According to the invention a brushless DC motor will be employed with an electronic motor controller to control the characteristics of the motor output speed and torque. It is an object of this invention to provide a gradual speed ramp up and ramp down to minimize the inertial reaction forces transmitted to the operator and thereby prevent an adverse reaction for the operator to counteract while standing on a potentially small elevated platform.

An additional object of the invention is to provide an intrinsically safe power tool motor, and controller which does not create an arc during its operation.

An additional object of the invention is to construct the power tool with an electrical switching system which does not create an arc while allowing the operator to effectively control the power supply to the motor controller and additionally to control the forward and reversing direction of the motor.

Another object of the invention is to provide an electric switching and motor reversing switch which is interlocked so as to preclude inadvertent motor reversal while in operation.

Another object of the invention is to provide a configuration of power tool which allows the operator to easily control the reaction forces due to a relatively large torque transmission.

Another objective of the invention is to provide a power tool which is salt spray and rain resistant.

Another objective of the invention is to provide a power tool which does not transmit significant EMI.

Another object of the invention is to provide a power tool which has an efficient means of transferring heat from the internally sealed motor and controller space to the exterior environment.

Another object of the invention is to provide a power tool which transmits a relatively large amount of torque and power compared with typical commercially available power tools with additional means to prevent excess torque from causing damage to the application.

Another object of the invention is to provide a method of loading ammunition into a gun or cannon with which the reaction forces are easily controlled and less fatiguing for the user and accomplishes the task in a shorter period of time than current methods. The method disclosed is intrinsically safe to be used near possible exposure to liquid fuels. The method disclosed also is protected from degradation when exposed to water spray and salt fog environments.

Another object of the invention is to provide a method of raising and lowering the moveable portion of jet aircraft wings with which the reaction forces are easily controlled and less fatiguing for the user and accomplishes the task in a short period of time than current methods. The method disclosed is intrinsically safe to be used near possible exposure to liquid fuels. The method disclosed also is protected from degradation when exposed to water spray and salt fog environments.

Other objects, features and advantages of the present invention will be readily understood after reading the following detailed description together with the accompanying drawings.

### BRIEF DESCRIPTION OF THE FIGURES

FIG. 1 is a side longitudinal cross section view of the disclosed tool.

FIG. 2 is a longitudinal cross section view showing the center section of the sealed motor and controller compartment.

FIG. 3 is a cross sectional view of the motor controller compartment taken along line 3-3 of FIG. 2.

FIG. 4 is a longitudinal section view of the housing which encloses the cooling means and switching means.

FIG. 5 is a rear end view showing the interlocking switch quadrant in position 1.

FIG. 6 is a rear end view showing the interlocking switch quadrant in position 2.

FIG. 7 is a longitudinal section view of the disclosed tool, a power supply cable and an energy source.

FIG. 8 is a block diagram describing the electrical functions of the invention.

FIG. 9 is a cross sectional view of another exemplary motor and controller housing.

FIG. 10 is a cross sectional view of one of the two extruded aluminum pieces which together make the motor and controller housing.

FIG. 11A is a side view of a machining fixture that can be used to machine each half of the motor and controller housing pieces.

FIG. 11B is an end view of the machining fixture of FIG. 11A.

### DETAILED DESCRIPTION

As described below, a power transmission tool and system, designed for intrinsically safe operation, may include a brushless or sparkless motor, speed reducing means, a power controller, an arcless or sparkless power switch and motor direction switch, a right angle power transmission means, a torque limiting clutch, a power transmission coupling means, and heat transfer means are housed in a “L” shaped housing which has a human interface ergonomic handle to manage the forces due to torque transmission, and with a detachable power cable and an exterior power supply box.

The motor and controller are encased in a sealed housing which has external cooling fins and end plates which are sealably attached to the first end and second end of the motor housing. The speed reducing means may be a train of gears of the parallel axis or planetary design. The housing of the gears may be sealed to prevent water or dust ingress.

The lower speed shaft from the speed reducing means is attached to the right angle power transmission means. The means to transmit power at a right angle may be by use of any number of gearing types well known in the art including bevel, hypoid, spiral bevel, worm gear or the like.

A torque limiting clutch is attached to the output shaft of the right angle power transmission means. The output of the clutch is coupled to a power transmission drive coupling means. This means may be a ½″ male square drive to adapt to the ½″ square female socket for some of the possible applications mentioned above.

The motor and controller housing with external fins provide a heat transfer path to expel heat from the motor and controller. The motor may be fastened to the end plate of the enclosure. The motor is typically made from steel laminations. The housing with external fins and the end plates are preferably made from a light metal like aluminum or magnesium. The environmental temperature range requirements of the application cause a differential thermal expansion of the steel motor and preferred aluminum housings. This differential thermal expansion requires a space between the exterior of the motor and the interior of the housing.

Ideally heat is transferred most efficiently through direct contact without an air gap. An air gap reduces heat transfer substantially. Thus, to efficiently transfer the heat from the exterior of the motor through the space required for thermal expansion it is necessary to displace the air with a substance which has a higher heat transfer coefficient for example commonly known is one of many thermally conductive silicone grease which may have a thermal conductivity of approximately 0.002 Cal/sec. Cm .degree. C. A thermally conductive resin such as DeltaCast 153 from Wakefield Engineering is an alternative conductive filler.

The exterior of the motor housing has fins to increase the surface area which commonly known enhances the heat transfer through convection to the air. The disclosed design has a relatively large exterior surface area of approximately between 8 to 12 inches long by a perimeter of 40 to 60 inches providing a surface area of approximately 320 square inches to 720 square inches.

Typically, the application aboard an aircraft carrier has air movement due to the movement of the ship. This air movement will remove heat from the exterior fins.

The invention provides alternatively, for applications which may have minimal air movement, for a forced air movement across the external fins and an air entrainment wall which forces the air to move across the full length of the exterior fins. The air is forced across the fins by means of a blower which may be one of many known types typically either an axial fan or centrifugal fan may be employed.

The blower must be exposed to the exterior air to move air over the exterior of the fins. This blower must also be intrinsically safe which means it must make no electrical sparks or arcs in its normal operation. Typically the motor used for this application is a brushless DC motor with integral electronic controls.

The motor power must be controlled by an operator to energize and de-energize the motor. Additionally the direction of rotation of the motor must be selectable by the operator to allow selective direction change. The invention discloses a means to prevent movement of the reversing switch mechanism when the energizing switch is engaged.

The switching system must not create sparks or arcs during operation. The invention uses a magnetic reed switch which is mounted to a PC board which in turn is mounted in the housing. The energizing lever or trigger has a magnet attached which when moved proximate to the reed switch will cause the reed switch to make electrical contact and thereby energize the controller and motor. Similarly, a reed switch will be mounted to a PC board adjacent to the reversing lever. The reversing lever will have a magnet attached, which when placed proximate to the reversing reed switch will cause the controller to reverse motor direction.

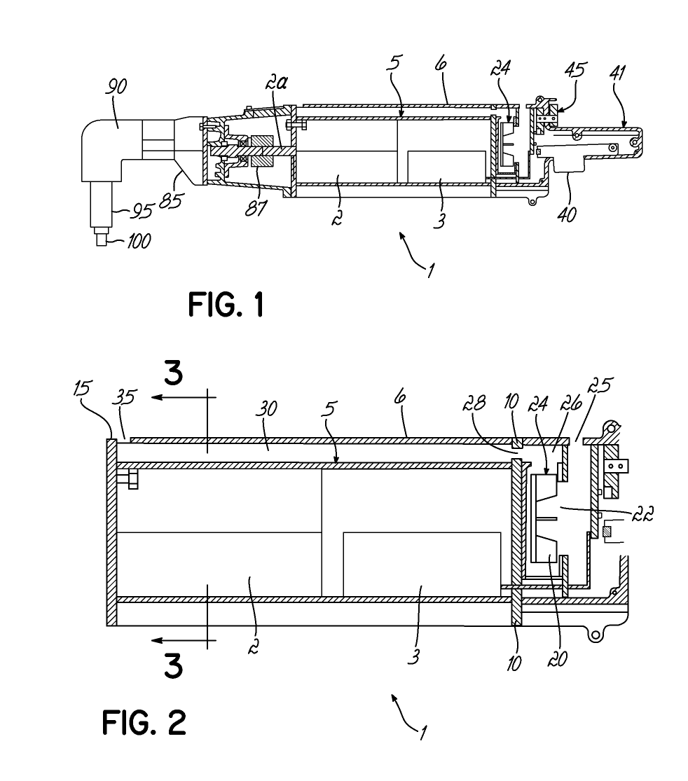

FIG. 1 shows a power tool 1 including a motor 2, a controller 3, and an enclosure or housing 5 which totally encloses the motor and controller. The motor 2 has an output shaft 2a which is rotationally coupled to a coupling 87. At the distal end of the power tool 1 is the speed reducing means 85 which is rotationally coupled to the coupling 87 and its output is rotationally coupled to the right angle power transmission means 90. The output of the right angle power transmission means 90 is coupled to a torsional torque limiting clutch 95 which is torsionally coupled to an output drive means 100, preferably a ½″ square drive. Attached to the motor and controller housing 5 at the proximal end is a handle housing 41 which encases a motor-energizing trigger 40 and motor-rotation-reversing lever 45. The handle 41 is displaced from the drive means 100 by a substantial distance, preferably more than 10 inches and as much as 40 inches, thus providing a large moment arm which minimizes the reaction force which the operator must control.

FIG. 2 shows an enlarged section view of the motor and controller housing 5, first end plate 10 and a second end plate 15 which together enclose the ends of the motor housing and seal it against ingress of water and dust by use of gaskets between the interface surfaces.

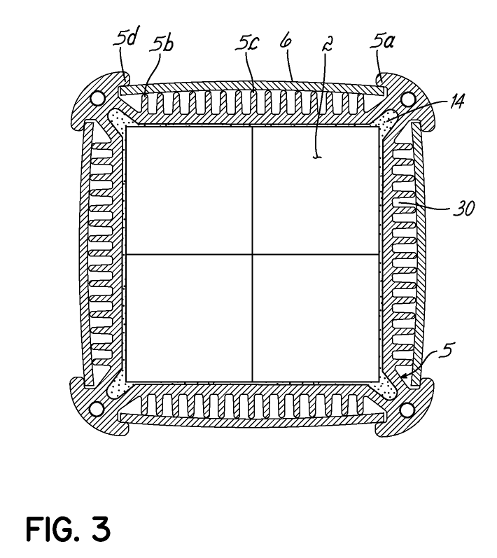

The motor is cooled by means of air flowing through the air intake ports 25 then into the blower 24 and the blower intake port 22. The blower blades 20 rotate centrifugally to cause a differential pressure thereby urging the air to flow to a blower exhaust chamber 26 of the blower 24. The air then is forced through ports 28 in the first end plate 10 into the channels 30 shown in FIG. 3 formed between cooling fins 5b. The present invention includes air entrainment walls 6 which force the air fully through the length of the channels 30 created by the fins 5b to finally exiting from the power tool 1 to the atmosphere through ports 35.

FIG. 3 shows a cross section of the motor 2 and motor and controller housing 5 with the air entrainment walls 6. The air entrainment walls 6 are retained by portions of the motor and controller housing 5 shown as 5a and 5d. The motor and controller housing 5 has longitudinal fins 5c and 5b representing many fins over its entire length. Fin 5c is shown to be longer than fin 5b. The walls 6 are manufactured as flat planar pieces. When the walls 6 are inserted in the space under the portion of the motor housing 5a and 5d, the walls must be compliantly bent over the larger fin 5c. This elastic bending of the walls 6 places a residual force on the walls so as to prevent vibration.

The motor 2 is mounted inside the motor and controller housing 5 leaving enough space for thermal contraction when exposed to at least as low as negative 40 degree. C. The space may be filled with a thermally conductive material 14 such as grease or resin to enhance heat transfer.

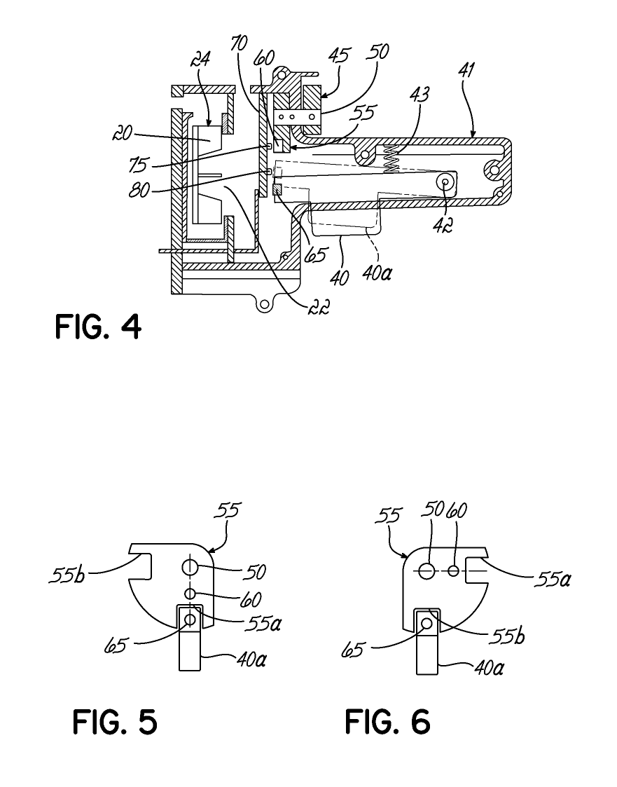

FIG. 4 shows the handle housing 41 which encases a trigger 40 shown in the de-energized position, and the trigger shown in the energized position 40a. The trigger 40 may be pivotally mounted and rotate around a pivot pin 42 and have a bias spring 43 which will return the trigger to the de-energized off position. Trigger 40 has mounted in it a magnet 65. When the trigger 40 is in the energized position 40a the magnet is positioned at a distance from a reed switch 80, the reed switch when open, causes the controller 3 to send power to the motor 2. When the trigger 40 is in the de-energized position the magnet is proximate to the reed switch 80 causing the reed switch 80 to be in a closed position thus interrupting the power supply to the motor 2 and controller 3.

A reversing lever 45 is rotationally moveable about an axis of a shaft 50, as further shown in FIG. 5 and FIG. 6, by the user to cause a reversal of direction of the motor 2. The lever 45 is fastened to shaft 50 by use of screws or keys or the like. A reversing quadrant 55 is also fastened to shaft 50. The reversing quadrant has a magnet 60 attached. When magnet 60 is positioned proximal to a “Fwd/rev” reed switch 75 the controller circuitry is changed to cause the motor 2 to rotate in a preferred direction.

When the magnet 60 is moved distally from the reed switch 75 the controller circuitry is changed to cause the motor 2 to operate in an opposite to the preferred direction.

FIG. 5 shows the reversing quadrant 55 in the preferred position with magnet 60 proximal to the reed switch 75. When in this position, the quadrant 55 has a slot 55a. Slot 55a allows space to allow the trigger 40a to enter. When trigger 40a is engaged with slot 55a the quadrant 55 is prevented from rotation about shaft 50.

FIG. 6 shows quadrant 55 rotated approximately 90 degrees counterclockwise from the position shown in FIG. 5. In this position the magnet 60 is in a distal location from the reed switch. In this position slot 55b is adjacent the trigger 40a allowing trigger to engage into slot 55b thereby prevent further rotation of the reversing quadrant 55 while trigger 40 in position 40a causes the motor to be energized.

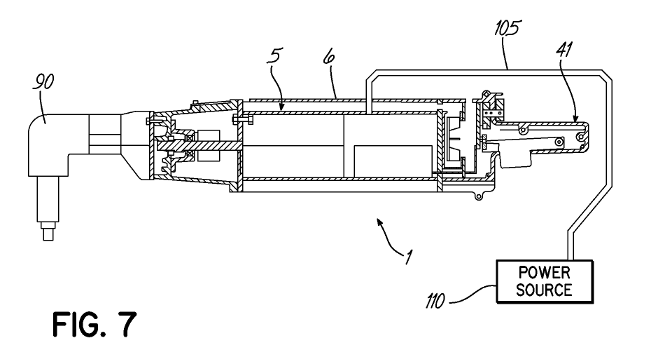

FIG. 7 shows power tool 1 and power cable 105 removably connected to a power source 110. The power source 110 is preferably a series of rechargeable batteries. The batteries may be of any voltage but preferably a high voltage is desired to reduce electrical losses due to requiring a lower electrical current.

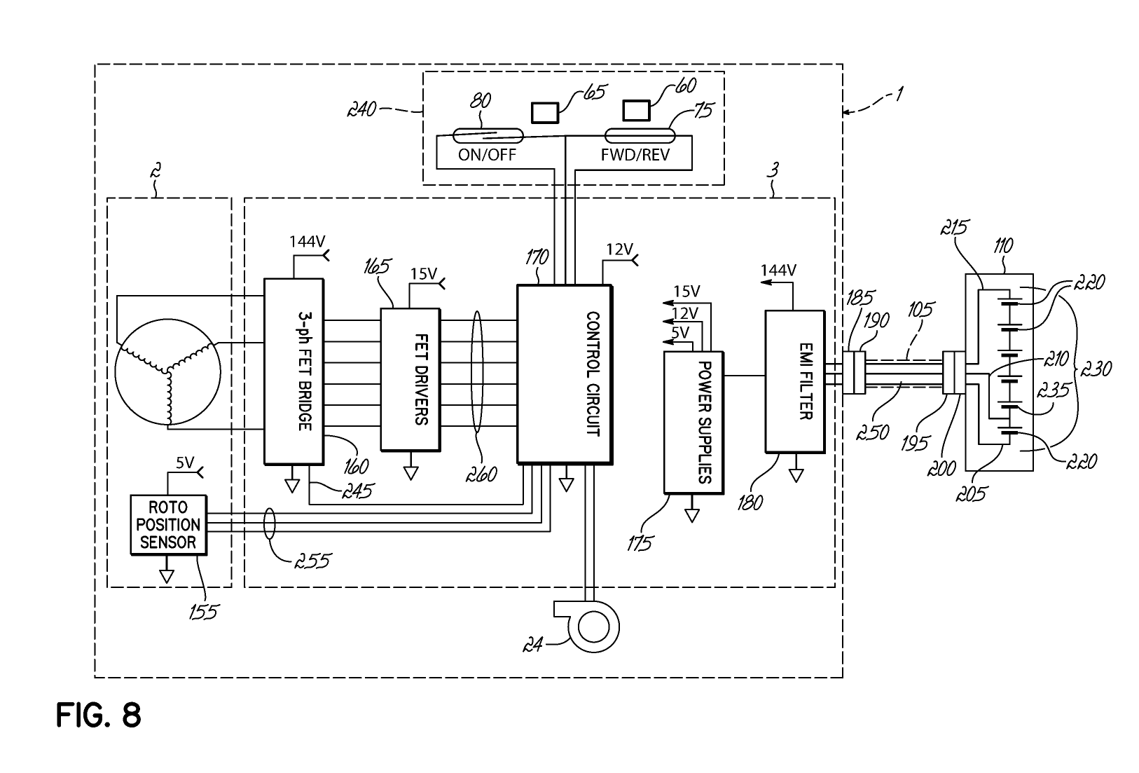

FIG. 8 shows power tool 1, including the motor 2, the controller 3, the blower 24, and switching means 240, connected by means of a cable 105 to a power source 110.

The motor 2 is a brushless DC motor consisting of a rotor (not shown), a poly-phase stator 150, and a rotor position sensor 155. In this preferred embodiment, the stator 150 has a typical three phase winding and the rotor position sensor 155 consists of three Hall sensors spaced at 120 electrical degrees. Other configurations would work as well and are to be considered within the scope of this invention.

The controller 3 consists of an electronic circuit residing in a housing made of a thermally conductive material preferably aluminum which serves as a heat sink and thermally conductive path to the motor and controller housing 5.

The components of the controller 3 include a FET Bridge section 160, a FET driver section 165, a main Control Circuit section 170, a power supply section 175, and an EMI filter section 180.

The FET Bridge section 160, in this preferred embodiment, consists of six FETs connected in a typical three-phase bridge circuit. While this embodiment uses FETS, other embodiment could use IGBTs without affecting the intent of the invention. The FET Bridge section 160 also contains a current sensor and a feedback path 245 to the main Control Circuit 170.

The FET Driver section 165 consists of circuitry that converts the six logical state signals from the main controller section 170 to gate drive signals for each of the six FETs in the FET Bridge section 160.

The heart of the controller 3 is the main Control Circuit section 170. This section reads and interprets the states of inputs and responds with appropriate outputs. The inputs to the main Control Circuit 170 are: the state of the “On/Off” reed switch 80, the state of the “Fwd/Rev” reed switch 75, the amplitude of the motor current as interpreted from current feedback path 245, and the rotor position and speed as interpreted from rotor position inputs 255 from the rotor position sensor 155.

The outputs of the main Control Circuit 170 are the six logical state signals 260 to the FET Driver section 165 and the voltage output to the blower 24. Depending on the state of reed switch 75, the commutation pattern of the six logical state signals 260 will drive the motor 2 in either the clockwise or counterclockwise direction. In addition to the commutation pattern, the six logical state signals 260 are pulse width modulated to control the speed of the motor 2.

The main Control Circuit 170 contains a closed loop speed control function which interprets the speed signal from the rotor position sensor 155, compares this signal to a factory set reference, and adjusts the pulse width of the PWM pulses of the six logical state signals 260. In this way, the speed of motor 2 is held constant throughout the normal load range.

Blower 24 (shown in FIGS. 2 and 4) is preferably of the centrifugal blower type having blower blades 20, air intake port 22, air exhaust chamber 26, an integral brushless DC motor 2, and an integral brushless DC motor controller 3. Blower 24 is located outside of the clean air environment defined by the volume enclosed by motor and controller housing 5, first end plate 10, and second end plate 15.

Therefore, to protect blower 24 from salt spray and rain, the integral control and the windings of the integral blower motor are sealed with a protective coating. One such coating is typically is known as potting with a polymeric resin. Another well known coating is a conformal coating. Blower 24 is energized only when the trigger 40 is depressed.

The operator of tool 1 controls the function of the device by means of the trigger 40 and the reversing lever 45 as previously described above with respect to FIGS. 4, 5, and 6. The electrical details of this user interface is shown in FIG. 8.

The switching means 240 consists of two reed switches, 75 and 80 and two magnets 60 and 65. The “On/off” reed switch 80 is actuated by magnet 65 mounted on the trigger 40. The “Fwd/rev” reed switch 75 is actuated by magnet 60 mounted on the reversing quadrant 55.

The reed switches 75 and 80 are connected to a Main Control Circuit 170 by means of three conductors. The common conductor is connected to ground potential.

When a magnet is made to approach a reed switch as shown in the case of the “Fwd/rev” reed switch 75, the switch 75 will go to the closed state and the Main Control Circuit 170 sees a logical “0” input. When a magnet is distal to a reed switch as shown in the case of the “On/off” reed switch 80, the switch will go to the open state and the Main Control Circuit will see a logical 1 input.

When the Main Control Circuit 170 receives a logical “1” at the “On/off” reed switch 80, the control energizes the blower 24 and starts the motor 2 slowly. The motor speed ramps up from zero rpm to full speed in about 0.5 seconds so as to limit the torque reaction transmitted to the operator and the equipment to which the tool is connected. The rotational direction during this ramp up and running of motor 2 is dependent on the logical state of the “Fwd/rev” reed switch 75.

In this embodiment, the power source 110 is an electrochemical battery 230 consisting of a plurality of serially connected sub-batteries 220. Battery 230 is tapped such that three electrical output wires are available. These wires are battery positive 215, battery negative 205, and a low voltage tap 210 that is connected at the serial junction of the most negative sub-battery and the next sub-battery 235 connected to it, thereby providing a dual voltage power source.

In this preferred embodiment, the battery 230 consists of five sub-batteries 220 and one sub battery 235, each sub-battery thereof consisting of 20 Nickel-Cadmium rechargeable cells or any of many well known types of rechargeable cell chemistry. Since the nominal voltage of a charged Nickel-Cadmium cell is 1.2 volts, the nominal voltage of each sub-battery is 24 volts and the nominal voltage of the complete battery is 144 volts.

Therefore, referring to the three electrical output wires connected to the battery, in this preferred embodiment, the voltage at wire 215 is nominally 144 volts, the voltage at wire 210 is nominally 24 volts, and wire 205 is still battery negative or zero volts.

For protection against physical abuse and the elements, battery 230 will be housed in one or more nested metal housings.

The three electrical output wires of the power source 110 are made available by means of electrical connector 200. Connector 200 consists of a plurality of electrical connection means preferably in the form of female sockets enveloped in a metallic shell that provides EMI (Electro-Magnetic Interference) shielding and means for electrically grounding the tool to the battery housing.

Other power supplies may be used within the scope of this invention such as a lower voltage battery supply commonly available on vehicles, including military vehicles such as 12 or 24 volts DC. This power supply may be modified into a higher voltage lower current source to supply power tool 1 with the preferred 144 volts by means of an inverter which is well known in the art.

Other power supplies which fall within the scope of this invention are electric generators producing either DC or AC wave forms. In the case of an AC wave form producing generator the power may be rectified to produce DC power which may be utilized by the power tool 1.

Also, mains power supply of any voltage may be used to energize power tool 1 by use of one of many power converters which convert and condition the wave form into the desired voltage and current needed.

Cable assembly 105 consists of connector 190, connector 195 and a length of multi-conductor cable 250 connecting the two. Connector 190 consists of a plurality of electrical connection means preferably in the form of female sockets enveloped in a metallic shell.

Connector 195 consists of a plurality of electrical connection means preferably in the form of male pins enveloped in a metallic shell. Connector 195 mates with connector 200 on the battery housing and connector 190 mates with connector 185 on the tool 1.

Connectors 185, 190, 195, and 200 are exemplified in the preferred embodiment by MIL-DTL-38999 series III connectors.

The multi-conductor cable 250 has a sufficient number of conductors to convey the three electrical output wires from the battery, plus a ground wire and, possibly, an outer shield to reduce EMI emissions from the cable as well as to protect the cable from abrasion.

At connector 185, the tool 1 is supplied with the three electrical output wires from the battery. Thus the tool 1 has two separate power inputs. One of these is a high voltage, high power input exemplified in the preferred embodiment as 144 volts. The other is a low voltage, low power input exemplified by 24 volts.

The three wires are fed through an EMI filtering section 180. The EMI filtering section consists of arrays of capacitors and inductors that are well known to those versed in the art.

After passing through the EMI filtering section 180, the high voltage, high power input is fed to the three phase FET bridge 160. The low voltage, low power input is fed to the internal power supply section.

The power supply section provides regulated low voltage supplies to the various other sections of the control 3. In the preferred embodiment, the power supply section feeds 12 volts DC to the main Control Circuit section 170, 15 volts DC to the FET Driver section 165, and 5 volts DC to the rotor position sensor 155 located in the motor 2. The power supply section produces the regulated voltages by means of three terminal linear voltage regulators as exemplified by the .mu.A78L00 series of positive voltage regulators from Texas Instruments.

Motor enclosures may be made from a variety of manufacturing methods. The motor and control housing 5 described above is ideally made from aluminum due to its relatively high thermal conductivity of about 0.49 Cal/ (sec CM ° C.). Aluminum in the shape described above is made typically using an extrusion process. This process has many advantages over casting processes, for example, surface finish and strength are better than sand or die casting processes. The extrusion process does not limit the length of the desired finished component since the process can produce parts which are more than a hundred feet or 30 meters long. Manufacturing such a housing using a CNC Machining process and starting with a solid billet of wrought aluminum is not economical and is subject to part warpage due to relief of internal stresses from the machining process. Aluminum extrusions however are not precise dimensionally. If an extruded aluminum motor and controller housing 5 was to fit a motor 2, for example, with a dimension of 3.5 inches by 3.5 inches outside dimension, the enclosure, if made from an extrusion process, would have a manufacturing process tolerance of as much as plus or minus 0.048 inch. Therefore, the housing would have to be larger than about 3.500 inches+0.048 inch, or about 3.548 inches, plus additional clearance of about 0.005 inch, to total about 3.553 inches to allow it to be inserted into the square extruded aluminum enclosure. This would leave an air gap of up to about 0.027 inch per side if the enclosure were made to the largest size of 3.553 inches. This air gap would be filled with the thermally conductive compound therefore improving the thermal conductivity compared to an air gap. Due to the length of necessary motor it is not practical to machine finish the inside of a closed enclosure to a more precise dimension.

Aluminum extrusions, such as motor and controller housing 5, may be made with a two part extrusion die. The exterior perimeter of the enclosure is formed with one die. The inside perimeter of the enclosure is formed with a second die. The second die must be positioned concentrically and held in that position with very strong struts. The aluminum billet is compressed under a tremendous amount of pressure to cause it to flow around the struts and through the space remaining between the outer and inner dies to form the shape shown in motor and controller housing 5. This two part die is more expensive than a one part die and must run on a larger extrusion machine.

The compound described above is used to improve heat transfer from internal components like a motor and electronic controller. The compound described above has a thermal conductivity of about 0.002 Cal/ (sec CM ° C.). Thermal conductivity will be increased linearly with a reduced thickness of said thermal compound. Thermal conductivity would be improved by nearly 250 times if the motor and electronic components could be in intimate contact with the aluminum motor and controller housing 5.

Therefore, it is an object of this invention to provide housing which can be made from the extrusion process yet provide a minimal amount of thermal compound to conduct heat away from the motor.

An additional object of the invention is to provide a housing which can be made from the extrusion process yet provide intimate contact with the motor and electronic control considering manufacturing dimensional tolerances.

Another object of the invention is to provide a housing which can be made from the extrusion process yet made with a one part die.

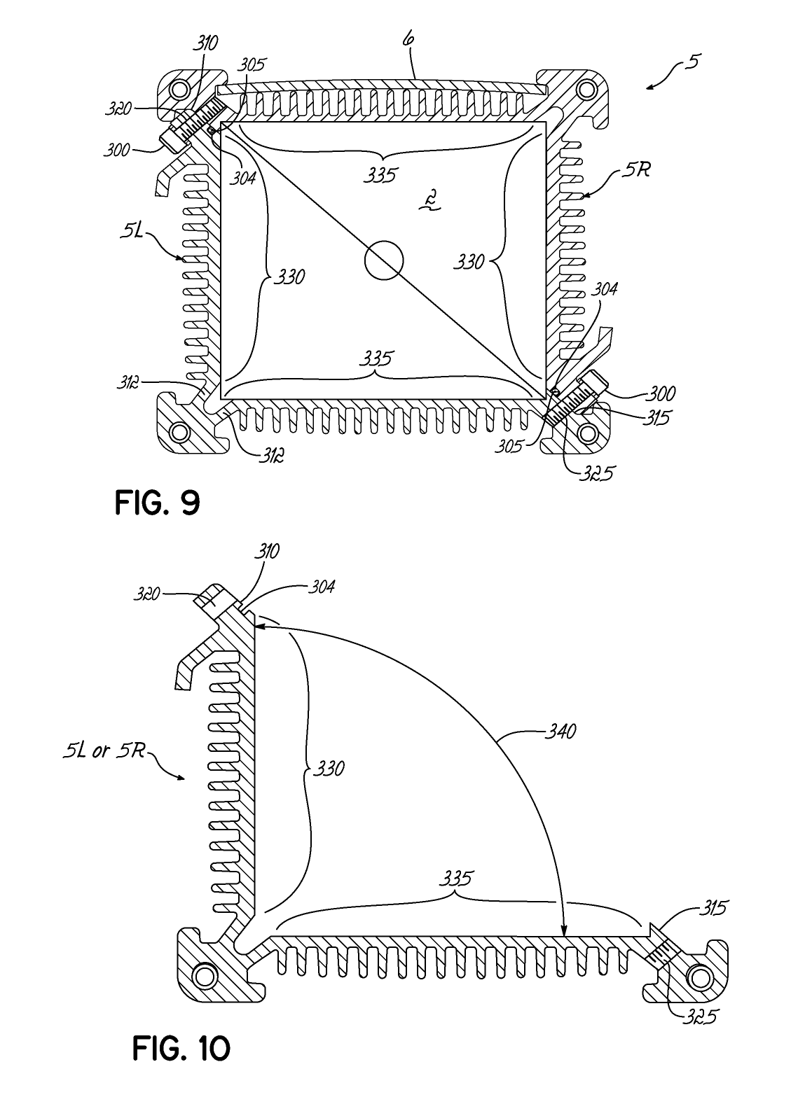

FIG. 9 depicts an exemplary motor and controller housing 5 comprising two components 5L and 5R. Components 5L and 5R may be made from aluminum or other material using an extrusion process. Components 5L and 5R may be made to be identical halves when assembled together to form a precise motor and controller housing 5 to enclose said motor 2 with intimate metal to metal contact at surfaces 330 and 335. Surfaces 310 and 315 are precision machined surfaces which are machined such that first metal to metal contact is made between the surfaces 330 and 335 and motor 2. Screw clearance holes 320 and threaded holes 325 are machined into the components 5L and 5R of the housing. Groove 304 is machined into each half of 5L and 5R to accommodate an “O” Ring 305 which upon final assembly of the said enclosure halves 5L and 5R will compress to seal out liquids and gasses from the motor housing enclosure.

Screws 300 are used to assemble the housing components 5L and 5R and thereby compress or maintain metal to metal contact between the motor 2 and the housing components 5L, 5R. Walls 312 provide a discontinuity in the motor and controller housing 5. Upon tightening of the screws 300, walls 312 provide a degree of flexibility to the motor and controller housing 5 to allow it to maintain intimate contact with the motor 2 without causing undue stresses from compression.

The motor 2 may be machined to a precise outside dimension of approximately plus or minus 0.001 inch. The motor and controller housing 5 may be machined to an accuracy of about plus or minus 0.002 inch. With such a level of accuracy the housing 5 may be sized to make intimate contact when the motor 2 is the largest and housing 5 the smallest. In the largest gap condition the total gap would be about 0.002 inch plus about 0.004 inch, or a total of about 0.008 inch. This would yield a gap of about 0.004 inch per side. This gap could be filled with said thermal compound. However compared to a conventional full perimeter extrusion the gap of up to about 0.027 inch would be reduced to about 0.004 inch, or a 6.75 times increase in thermal conductivity.

With such a level of accuracy the motor and controller housing 5 may be sized to make intimate contact at all possible tolerances of motor 2 and motor and controller housing 5. In this condition the housing walls 312 would flex to accommodate the possible 0.008 inch compression such that each of the four walls 312 would stretch a small amount.

Referring to FIG. 10, the un-machined housing component 5L made from extruded material is shown. The standard extrusion tolerances expected for this part are described. The length of line or surface 335 and 330 may be as much as plus or minus 0.024″. The accuracy of the angle 340 may be as much as plus or minus 1.0 degree. This calculates to allowing the surface 310 to be out of position by as much as plus or minus 0.060″ due to the aluminum material warping after leaving the extrusion die and solidifying and cooling. This condition must be mitigated to provide a precision motor and controller housing 5.

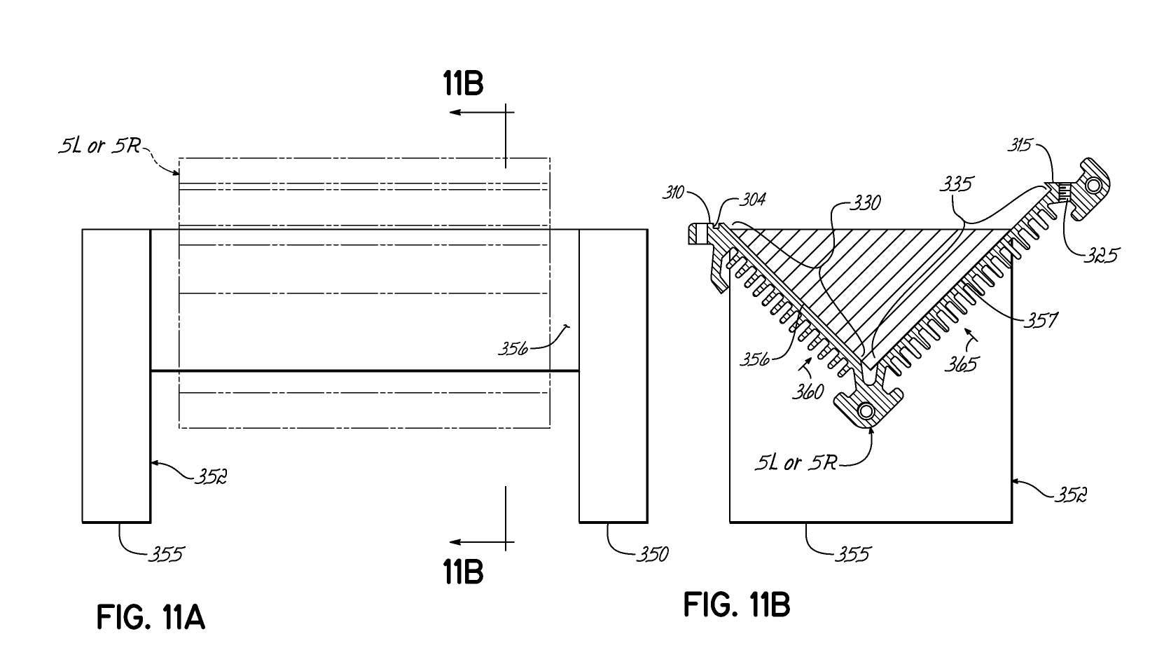

Referring now to FIG. 11, a machining fixture 352 is described, having mounting surfaces 350 and 355, angled surfaces 356 and 357 which are contiguous with said mounting surfaces. Housing component 5L is placed under and pushed against said angled surfaces with a force in directions 360 and 365. Said machining fixture may be a precision hardened steel jig ground fixture, well known in the industry and made to an accuracy of about plus or minus 0.0001 inch. This level of precision provides a nearly exact angle between surfaces 356 and 357. When the un-machined housing component 5L is clamped to the machining fixture the plus or minus 1 degree warp is removed causing the material to conform to the machining fixture precise angle. While in this constrained position all the surfaces 310, 335, holes 320, and groove 304 are machined to the high level of accuracy which typical CNC Machining centers are capable of in today's manufacturing environment.

While the present invention has been illustrated by the description of one or more exemplary embodiments, and while the embodiments have been described in considerable detail, they are not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A power tool, comprising:
a motor;
a controller; and
a motor and controller housing, said motor and said controller disposed within said motor and controller housing, with said motor sealingly coupled with said motor and controller housing to prevent the intrusion of liquids and gasses;
said motor and controller housing comprising first and second components assembled in an interfitting relationship such that said motor and controller housing directly contacts said motor.

2. The power tool of claim 1, wherein said first and second components are extruded components.

3. The power tool of claim 1, wherein said first and second components are identically formed parts configured to interfit and thereby form said motor and controller housing.

4. The power tool of claim 1, wherein said first and second components are sized and configured such that at least one of said first or second components is deformed and directly contacts said motor and controller housing when said first and second components are assembled to enclose said motor and said controller therein.

5. A fixture for manufacturing a housing component for a tool, the fixture comprising:
a base defining first and second support surfaces, said first and second support surfaces angularly disposed with respect to one another to receive at least a portion of the housing component therebetween; and
a pressing member configured to be received between said first and second support surfaces such that said pressing member urges the housing component against said first and second support surfaces when the housing component is clamped within the fixture, while surfaces of the housing component remain exposed for machining operations.
